(19) United States
(12) Patent Application Publication
(10) Pub. No.: US 2016/0277563 A1
(43) Pub. Date: Sep. 22, 2016

(54) MOBILE DEVICE CARRIER

(71) Applicant: Richard Chan, Fjerdingby (NO)

(72) Inventor: Richard Chan, Fjerdingby (NO)

(21) Appl. No.: 15/075,293

(22) Filed: Mar. 21, 2016

(30) Foreign Application Priority Data
Mar. 19, 2015 (GB) 1504700.4

(51) Int. Cl. H04M 1/725; H04M 1/02

(52) U.S. Cl. CPC H04M 1/72588; H04M 1/0241; H04M 1/7258; H04M 1/72541

(57) ABSTRACT

A mobile device carrier includes a back panel configured to receive and electrically couple with a mobile device, so as to at least partially cover a back of the mobile device, and a cover panel pivotally coupled with the back panel. The cover panel includes an interior surface configured to at least partially cover a front face of the mobile device and including a first set of actuators arranged to enable a user to enter data into the mobile device, and an exterior surface including a second set of actuators arranged to enable input to the mobile device. The mobile device carrier further includes a computer program product embodied as computer-readable instructions stored on a non-transient, computer-readable memory and executable by the mobile device to perform functions of the mobile device in response to actuation of the first and second set of actuators.

### BACKGROUND

Keypads/keyboards deployed in limited space in the mobile phone devices generally mean that the keys are small or that multi-functional paging is required. Usage of keypads such as QWERTY keypad can be inconvenient as they require paging to access the full combination of inputs. Also, accurate access can be a problem with QWERTY keypads with small keys. An alternative to the QWERTY keypad is touch screen interface in smart phones.

However, the touch screen interface presents varying problems to all users at various degrees of severity. Types of problems vary according to individuals but in most cases, the major problem is not hitting the right key due to the close key layout and the necessity of paging between numbers, alphabets and punctuation marks. Few smart phones include an integrated keypad as an alternative to the touch screen interface for allowing users to enter data/text. However, the integrated keypad is based on the standard T9 approach which is the same as for traditional phones. In other touch screen interfaces, the icons for the applications have a larger size, some icons have larger squares and others have scrolling icons/applications presentation.

However, for users with fine motor skills impairment, and those who need special attention or assistance, both traditional keypads and touch screen interfaces present difficulties in terms of locating the correct key and activating a desired selection. These kinds of users may resort to specially made equipment for using their mobile devices, however, that equipment is generally expensive.

Further, in a conventional keyboard, a keypad includes a key that supports several functions. In operation, all fingers needs to be used and the keypad unit has to be placed on a flat top. However, the user may not hold the keypad in his/her hands. Another conventional keyboard includes a single row of keys, and each key has to be tilted in one of the four directions for activation. The keys can have raised surrounding edges or it can be convex in form with a central raised top with four sloping sides or it can be flat with raised profiles. Yet another conventional keyboard includes a keyboard array that has five facets, four along the edges and a fifth in the centre. The four faces slopes down towards the centre. Activation of an input is by pressing on one of the slopping faces where a switch is activated to give the signal. Further, activation of a key function in the middle enables at least two switches to be activated which then define a unique key. Activation of two switches requires some additional force, no matter how small that maybe, and ergonomically this represents a deviation to the force used when activating only one switch. Therefore, all the above-mentioned prior art focuses on different types of keyboards, and none of them provides a solution to the problems faced by the user in existing mobile smartphone devices.

Hence there is a need for a system and method that enables the users to use their existing mobile phones with ease and convenience without having to face the limitations associated with the touch screen interface and traditional keypads. The system and method should enable the users with fine motor skills impairment, and those who need special attention or assistance to locate the correct key and activate a desired selection, without using expensive equipment.

### SUMMARY

The present disclosure seeks to provide a mobile device carrier.

In one aspect, embodiments of the present disclosure provide a mobile device carrier including a back panel configured to receive and electrically couple with a mobile device, so as to at least partially cover a back of the mobile device and, pivotally coupled with the back panel, a cover panel. The cover panel includes an interior surface configured to at least partially cover a front face of the mobile device and including a first set of actuators arranged to enable a user to enter data into the mobile device and an exterior surface including a second set of actuators arranged to enable input to the mobile device. Further, a computer program product embodied as computer-readable instructions stored on a non-transient, computer-readable memory and is executable by the mobile device to cause the mobile device to perform functions in response to actuation of the first and second sets of actuators.

In accordance with an embodiment of the present disclosure, the first set of actuators includes a plurality of keys, each comprising a perimeter and an off-center depression configured to partially receive a finger of a user.

In accordance with an embodiment of the present disclosure, the plurality of keys includes a plurality of alphanumeric keys, a navigation key, a contact display key, a calendar key, a call termination key, a call answering key, an enter key, a key to switch to pointer mode, a backspace key, a right delete key, a shift key, a control key, a menu key, a home key, a back key, and one or more volume control keys.

In accordance with an embodiment of the present disclosure, at least one of the plurality of alphanumeric keys is a multi-language key enabling data input to the mobile device in a plurality of languages.

In accordance with an embodiment of the present disclosure, each key includes indicia corresponding with at least one action performed in response to user engagement with the key.

In accordance with an embodiment of the present disclosure, each key includes a pivot adjacent to a central portion, and first, second, third and fourth metal dome actuators adjacent to the perimeter and electrically coupled with the back and cover panels.

In accordance with an embodiment of the present disclosure, upon application of a force to a portion of the perimeter, the key is configured to unite the perimeter with one of the first, second, third and fourth metal dome actuators adjacent to the perimeter.

In accordance with an embodiment of the present disclosure, in response to motion of a finger within the off-center depression towards a portion of the perimeter, each key is configured to rock towards a portion of the perimeter and engage metal dome actuator to send a signal to the cover panel.

In accordance with an embodiment of the present disclosure, the mobile device is selected from at least one of: a smart phone, a tablet, a phablet, a webpad, and a mobile telephone.

In accordance with an embodiment of the present disclosure, the cover panel further includes a window through which a portion of the mobile device is viewable when the cover panel covers the front face of the mobile device, wherein the computer-readable instructions of the computer program product are further configured to cause the mobile device to present to a user at the window, at least one of: identification of a calling entity, call status, missed calls, new e-mail, new SMS, calendar notifications, radio signal and battery status.

In accordance with an embodiment of the present disclosure, upon actuation by a user, at least one of the second set of actuators is configured to answer a call incoming to the mobile device, at least one of the second set of actuators is configured to terminate a call received at the mobile device, at least one of the second set of actuators is configured to activate a loudspeaker of the mobile device, at least one of the second set of actuators is configured to turn on the back lighting of the keyboard, and at least one of the second set of actuators is configured to charge the cover panel, while the cover panel covers the mobile device front face.

In accordance with an embodiment of the present disclosure, at least one of the second set of actuators includes a programmable SOS button configured to transmit an emergency communication, and at least one of the second set of actuators includes an emergency button cover configured to cover the programmable SOS button to prevent false activation of a corresponding SOS application.

In accordance with an embodiment of the present disclosure, the transmitting of the emergency communication includes, in accordance with computer-readable instructions of the computer program product, at least one of: sending a preprogrammed alert SMS including GPS co-ordinates, to one or more predefined mobile numbers, and making an emergency call to a predefined phone number.

In accordance with an embodiment of the present disclosure, the mobile device carrier further includes a serial bus plug configured to operatively couple the mobile device carrier to a serial bus port of the mobile device, wherein the first and second sets of actuators are configured to operatively couple with the mobile device through the serial bus plug to perform functions of the mobile device in accordance with computer-readable instructions of the computer program product.

In accordance with an embodiment of the present disclosure, the first and second sets of actuators are configured to operatively couple with the mobile device through a personal area communications network to perform functions of the mobile device in accordance with computer-readable instructions of the computer program product.

In accordance with an embodiment of the present disclosure, the computer readable instructions are stored locally in a memory of at least one of: the mobile device and mobile device carrier.

In accordance with an embodiment of the present disclosure, the computer program product is further executable to cause the mobile device to display at least one supplemental user interface in addition to a home screen of the mobile device.

In accordance with an embodiment of the present disclosure, in response to pivoting of the cover panel interior surface into an abutting relationship with the back panel followed by pivoting of the cover panel interior surface away from the back panel, the mobile device is reset to a predetermined home page of the at least one supplemental user interface.

In accordance with an embodiment of the present disclosure, the at least one supplemental user interface includes a contact display area configured to display one or more contacts of the mobile device in an image format, a dialing icon configured to cause the mobile device to dial one of the one or more contacts in response to a selection of an image of the one contact in the contact display area, a message composer icon configured to cause the mobile device to initiate message composition for one of the one or more contacts in response to a selection of an image of the one contact in the contact display area, and an email composer icon configured to cause the mobile device to initiate email composition for one of the one or more contacts in response to a selection of an image of the one contact in the contact display area.

In accordance with an embodiment of the present disclosure, the contact display area includes a keypad including a plurality of number keys and a plurality of character keys.

In accordance with an embodiment of the present disclosure, the at least one supplemental user interface displays a call log icon configured to cause a presentation of call logs in response to actuation of the call log icon, a message log icon configured to cause a presentation of message logs in response to actuation of the message log icon, and an application display area configured to cause a presentation of at least one user selectable application therein.

In accordance with an embodiment of the present disclosure, the at least one supplemental user interface includes a first emergency icon configured to activate an SOS application to transmit an emergency communication.

In accordance with an embodiment of the present disclosure, the at least one supplemental user interface includes a medical emergency icon configured to activate a medical emergency application to retrieve and display a password protected personal information file stored in corresponding memory for use in a medical emergency.

In accordance with an embodiment of the present disclosure, the at least one supplemental user interface includes a pointing device controlled by a navigation key of the plurality of first actuators or the plurality of second actuators.

In accordance with an embodiment of the present disclosure, the computer program product is further executable to cause the mobile device to automatically answer calls in accordance with user programming, transmit current GPS coordinates of the mobile device to predefined numbers, handle remote GPS interrogation and periodic GPS position transmission in accordance with user programming, and organize one or more user defined applications

Embodiments of the present disclosure provide a mobile device carrier that includes an alphanumeric keypad for integration with an existing smart phone to achieve ease of text entry for users who cannot use the ubiquitous touch screen in their smartphones. The keys of the alphanumeric keypad are designed to have an off-center depression displaced towards the top part of the key to allow a better fit to the fingertip and facilitate use of the softer part of the finger tip for key depression. The mobile device carrier further converts an existing smart phone into a flip phone, where the corresponding flip cover includes the feature of displaying the caller identity, notification for missed call, new SMS, etc and allowing the user to answer/reject an incoming call without opening the flip cover. The flip cover also enables the user to seek emergency assistance and location interrogation without opening the flip cover. The mobile device carrier further enables a supplemental user interface on the mobile device apart from a default home screen, where the supplemental user interface provides one touch call generation, SMS and email generation, all amounting to ease of use. The supplemental user interface combines the functions of direct dialing, direct SMS and e-mail generation, access to SOS function and ICE personal and medical data, personal details file, answering calls in accordance with user programming, transmitting current GPS coordinates of the mobile device to predefined numbers, handling remote GPS interrogation and periodic GPS position transmission, and organizing one or more user defined applications

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein.

Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example mobile device carrier, in accordance with an embodiment of the present disclosure;

FIG. 2a is a schematic illustration of an open position of an example mobile device carrier, while carrying a mobile device, in accordance with an embodiment of the present disclosure;

FIG. 2b is a schematic illustration of a first closed arrangement of the mobile device carrier carrying a mobile device, in which a switch cover is in an open position allowing for actuation of an SOS button, in accordance with an embodiment of the present disclosure;

FIG. 2c is a schematic illustration a second closed arrangement of the mobile device carrier carrying a mobile device, in which switch cover is in a closed position to prevent unintended actuation of SOS button, in accordance with an embodiment of the present disclosure;

FIG. 3a is a schematic illustration of a top view, front view and a right side view, of a key of the alphanumeric keypad of the mobile device carrier, in accordance with an embodiment of the present disclosure;

FIG. 3b is a schematic illustration of the side view showing an off-center depression of the key, in accordance with an embodiment of the present disclosure;

FIG. 4 is a schematic detailed illustration of an example layout of a keypad of the mobile device carrier, in accordance with an embodiment of the present disclosure;

FIGS. 5a-5c are schematic illustrations of example first, second and third user interfaces of the mobile device, in accordance with an embodiment of the present disclosure;

FIG. 5d is a schematic illustration of a sub-menu displayed upon tapping of an application menu of the third user interface, in accordance with an embodiment of the present disclosure; and

FIG. 6 is a schematic detailed illustration of a user interface of the mobile device, corresponding to a launcher application ‘EziStart’ executing therein, in accordance with an embodiment of the present disclosure.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the present disclosure provide a mobile device carrier that includes a back panel configured to receive and wirelessly or electrically couple with a mobile device, so as to at least partially cover a back of the mobile device, and a cover panel pivotally coupled with the back panel. The cover panel includes an interior surface configured to at least partially cover a front face of the mobile device and including a first set of actuators arranged to enable a user to enter data into the mobile device, and an exterior surface including a second set of actuators arranged to enable input to the mobile device. The mobile device carrier further includes a computer program product embodied as computer-readable instructions stored on a non-transient, computer-readable memory and executable by the mobile device to perform functions of the mobile device in response to actuation of the first and second set of actuators.

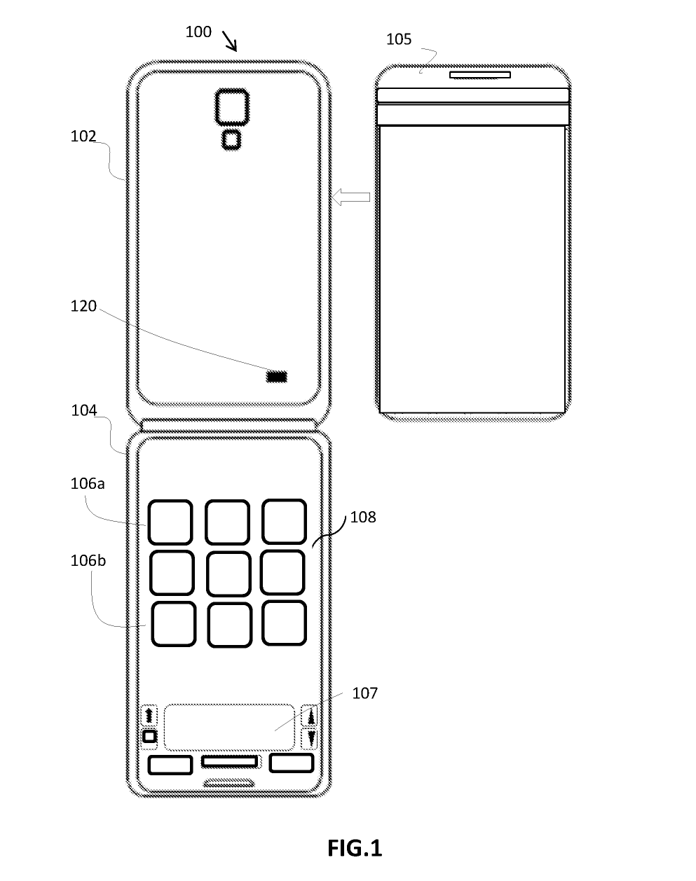

Referring to figures, FIG. 1 is a schematic illustration of a mobile device carrier 100, in accordance with an embodiment of the present disclosure. The mobile device carrier 100 is formed of a back panel 102, and a cover panel 104 pivotally coupled with the back panel 102. The cover panel 104 is configured to pivot between an open position in which an interior surface 108 thereof is spaced and angled apart from the back panel 102 to a closed position in which the interior surface 108 abuts the back panel 102. The back panel 102 is configured to receive and house a mobile device 105 so as to at least partially cover a back side of the mobile device 105. Examples of the mobile device 105 include, but are not limited to, a smart phone, a tablet, a phablet, a webpad, a mobile telephone, or any other mobile phone that has a touch screen user interface.

The interior surface 108 of the cover panel 104 is configured to at least partially cover a front face of the mobile device 105 and includes a first set of actuators 106a and 106b arranged to enable a user to enter data into the mobile device 105. Examples of the actuators 106a and 106b, include, but are not limited to keys and buttons. In an example embodiment of the present disclosure, the first set of actuators 106a and 106b form an alphanumeric keypad 106 for the mobile device 105. The cover panel 104 further includes a window 107 through which a portion of the mobile device 105 may be viewed when mobile device carrier 100 is closed with the cover panel 104 flipped over the back panel 102.

The back panel 102 may include a serial bus plug 120 configured to operatively couple the mobile device carrier 100 to a serial bus port (not shown) of the mobile device 105, and the first set of actuators 106a-106b may be configured to operatively couple with the mobile device 105 through the serial bus plug 120 to perform one or more functions of the mobile device 105. Examples of the serial bus plug 120 suitable for use with mobile devices, include, but are not limited to, a USB connector facilitating inter-communication between the mobile device 105 and the mobile device carrier 100.

FIG. 1 is merely an example, which should not unduly limit the scope of the claims herein. A person skilled in the art will recognize many variations, alternatives, and modifications of presently disclosed embodiments.

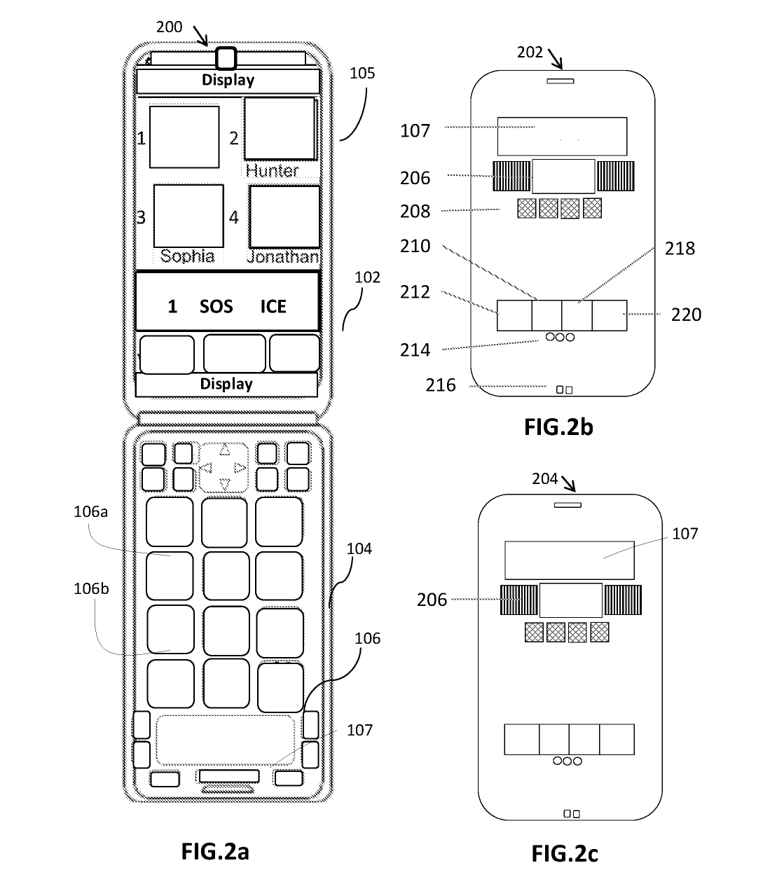

FIG. 2a is an illustration of an open position 200 of the mobile device carrier 100, with the back panel 102 in receipt of the mobile device 105, in accordance with an embodiment of the present disclosure. The mobile device 105 is received by the back panel 102 and forms an integrated unit resembling a flip phone, in which the cover panel 104 provides a flip cover. Upon placement into the back panel 102, the mobile device 105 may be operated using the alphanumeric keypad 106. In an embodiment, the alphanumeric keypad 106 is integrated with the mobile device 105 using a personal area communications network, for example, one configured to operate within ultrahigh frequency range including but not limited to Bluetooth. Embodiments of the mobile device carrier 100 providing for integration of the alphanumeric keypad 106 with the mobile device 105 by personal area communications network may or may not also include the serial bus plug 120.

FIGS. 2b and 2c are illustrations of first and second closed positions 202 and 204 of the mobile device carrier 100 respectively, in which the mobile device 105 is has been received onto the back panel 102 and the cover panel 104 has been pivoted to flip over back panel 102 to close mobile device carrier 100, in accordance with an embodiment of the present disclosure. The cover panel 104 includes the window 107 which provides a partial view of the display screen of the mobile device 105 in the first and second closed positions 202 and 204. In an embodiment, the window 107 provides at least one of identification of calling entity, call status, missed calls, new e-mail, new SMS, low radio signal, low battery status, and calendar alert. In an example, the window 107 displays a phone number and caller id of an incoming call to the mobile device 105. In another example, the window 107 displays a colored indicator for notifying any new activity such as a missed call or new SMS.

For operating the mobile device 105 during the closed positions 202 and 204, the back side of the cover panel 104 includes a SOS button 206, a SOS switch cover 208 for covering the SOS button 206 (FIG. 2c) and preventing false activation of SOS functionality, a switch 210 for activating back lighting of the alphanumeric keypad 106, a call answering button 212, LED indicator lights 214 for indicating battery status of the mobile device 105, connectors 216 for charging of the cover panel 104, a loudspeaker activation button 218, and a call termination button 220.

The SOS button 206 is a programmable emergency button (also referred to as SOS actuator) arranged to transmit an emergency communication. Upon actuation of SOS button 206, the mobile device 105 may be configured to make an emergency/SOS call, make a priority dedicated call to a pre-defined number, send SMS to a predefined number, or send GPS location co-ordinates to a predefined number.

In an embodiment, a user may answer an incoming call by opening the cover panel 104 and reject an incoming call by first opening the cover panel 104 and then closing it. In another embodiment, the mobile device 105 is configured to reset and display a predetermined home page, when the user pivots the cover panel 104 interior surface into an abutting relationship with the back panel 102 and subsequently pivots the cover panel 104 interior surface away from the back panel 102 and out of the abutting relationship. Thus, the mobile device carrier 100 facilitates user operation and execution of functions of the mobile device 105 without necessitating use of any touch screen interface of the mobile device 105.

FIGS. 2a-2c are merely examples, which should not unduly limit the scope of the claims herein. A person skilled in the art will recognize many variations, alternatives, and modifications of presently disclosed embodiments.

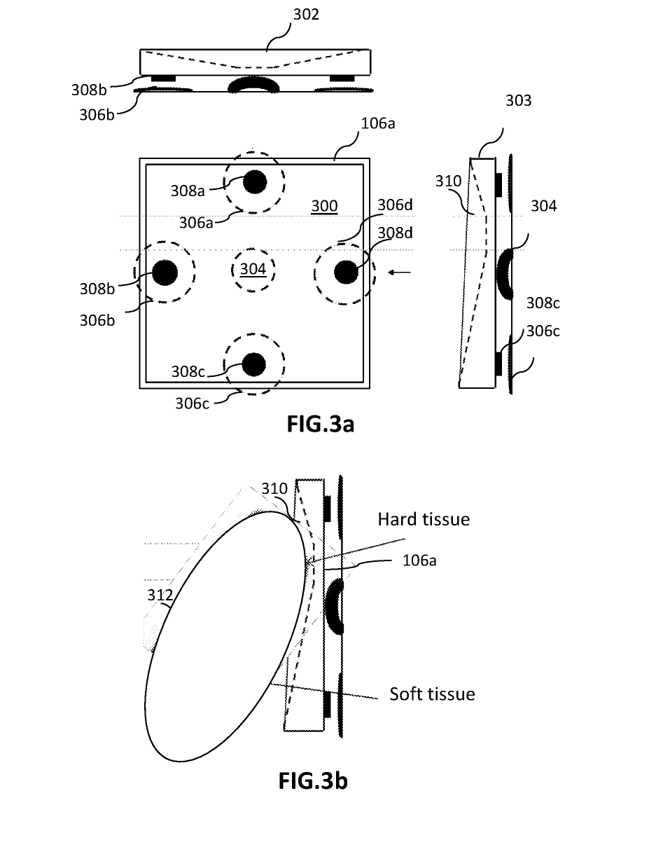

FIG. 3a is a schematic illustration of a top view 300, a front view 302 and a right side view 303 of a key 106a of the mobile device carrier 100, in accordance with an embodiment of the present disclosure.

The key 106a includes a pivot 304 at a central portion, and metal dome actuators 306a, 306b, 306c, 306d (hereinafter collectively referred to as metal dome actuators 306) at back, left, front and right portions respectively. The key 106a further includes studs 308a, 308b, 308c, 308d (hereinafter collectively referred to as studs 308) for contacting corresponding metal dome actuators 306. For example, stud 308a is arranged to contact metal dome actuator 306a. Each metal dome actuator 306 provides an electrical contact electrically coupled with the back panel 102. Upon application of a force on a stud 308, the corresponding metal dome actuator sends a signal to the back panel 102. Character selection on the key 106a may be performed by locating the finger in the off-centre depression displaced up from 304 and pushing in one of back, front, right or left directions to rock the key 106a about centre 304 to activate one of the metal dome actuators 306a, 306b, 306c, 306d. Alternatively, a user may push directly on one of the edges of the key 106a. The key 106a is pivoted at pivot 304 (FIG. 3b) to employ momentum for assisted force and comfort of usage. When pressure is applied to the centre of key 106a, the pivot 304 prevents its depression, maintaining all studs 308 away from all of metal dome actuators. Therefore, activation of the key 106a is prevented.

FIG. 3b is a schematic illustration of the side view showing an off-center depression 310 of the key 106a, in accordance with an embodiment of the present disclosure. In an embodiment, the top of the key 106a is designed to have the off-center depression 310 displaced towards the top part of the key. The depression 310 is generally configured to partially receive a finger of a user (for example a fingertip), and, as set forth above, is not associated with any character selection. This allows a better fit to the fingertip 312 and facilitates the use of the softer part of the finger tip 312 for actuator depression.

FIGS. 3a-3b are merely examples, which should not unduly limit the scope of the claims herein. A person skilled in the art will recognize many variations, alternatives, and modifications of presently disclosed embodiments.

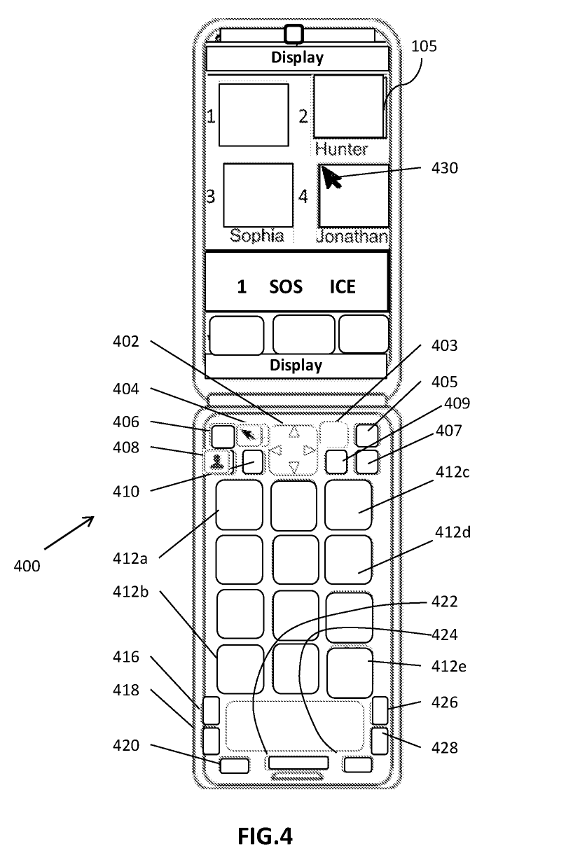

FIG. 4 is a schematic detailed illustration of an example layout of a keypad 400, (which is an example of the keypad 106 formed in a cover panel 104 of the mobile device carrier 100), in accordance with an embodiment of the present disclosure. The layout of the keypad 400 is irrespective of the user interface of the mobile device 105, as it is a part of the cover panel 104. In an embodiment, the mobile device carrier 100 may be provided with a computer program product embodied as computer-readable instructions stored on a non-transient, computer-readable memory and executable by the mobile device 105 to perform one or more functions in response to actuation of at least one of the keys of the keypad 400.

Further, in accordance with the computer-readable instructions, the mobile device 105 operates in two modes—normal mode and integrated mode. The normal mode defines the mode of operation of the mobile device 105, where it operates independently of the mobile device carrier 100. The integrated mode defines the mode of operation of the mobile device 105, when the features and functions of the mobile device 105 are integrated with that of the mobile device carrier 100. For example, in the integrated mode, the mobile device 105 can be operated through the keypad 400 which is connected thereto through a personal area communications network.

The keypad 400 includes a navigation key 402, a calendar key 403 for displaying a calendar, a pointer key 404 for displaying a pointer, a call termination key 405, a call answering key 406, an enter key 407, a contacts key 408 for displaying contacts, a backspace key (left delete) 409, and a right delete key 410.

The keypad 400 further includes twelve alphanumeric keys such as keys 412a, 412b, 412c, 412d and 412e (hereinafter collectively referred to as alphanumeric keys 412), where each key includes indicia representing corresponding plurality of actions/functions. For example, the key 412a which includes the indicia ‘ESC’ may be referred to as escape key as it is operable to actuate an escape function; the key 412b which includes arrow indicia may be referred to as tab key; the key 412e which includes as indicia a number of characters from a plurality of languages may be referred to as multi-language key as it facilitates use of multiple languages supported by the keypad 400.

The keypad 400 further includes a shift key 416, a control key 418, a menu key 420, a home key 422 corresponding to a home key of the corresponding mobile device 105, a back key 424 corresponding to a back key of corresponding mobile device 105, volume control keys 426 and 428, and a pointer 430 associated with the pointer key 404.

The alphanumeric keys 412 may be of a type as disclosed with reference to FIGS. 3a and 3b, and may each include four or more different selections. With some of keys 412, additional selections may be accessed by prefixing actuation of the key with actuation of another key such as the Shift key 418. In an embodiment of the present disclosure, a function on an alphanumeric key 412 can be activated by directly pressing on the required function/character or by locating the required key, steadying the finger and rocking toward the top, bottom, right or left, as appropriate for the desired selection.

In an embodiment, the keypad 400 supports languages such as English, German, Norwegian, Swedish and Danish, and when the mobile device 105 is programmed to use the respective language, the combinations of special characters presented in Table 1 are valid.

TABLE 1

| | Valid special |
|---|---|
| Language | characters |
| German | ü, β, ä, ö |
| Norwegian | å, æ, ø |
| Swedish | ü, ä, ö |
| Danish | å, æ, ø |

FIG. 4 is merely an example, which should not unduly limit the scope of the claims herein. A person skilled in the art will recognize many variations, alternatives, and modifications of presently disclosed embodiments.

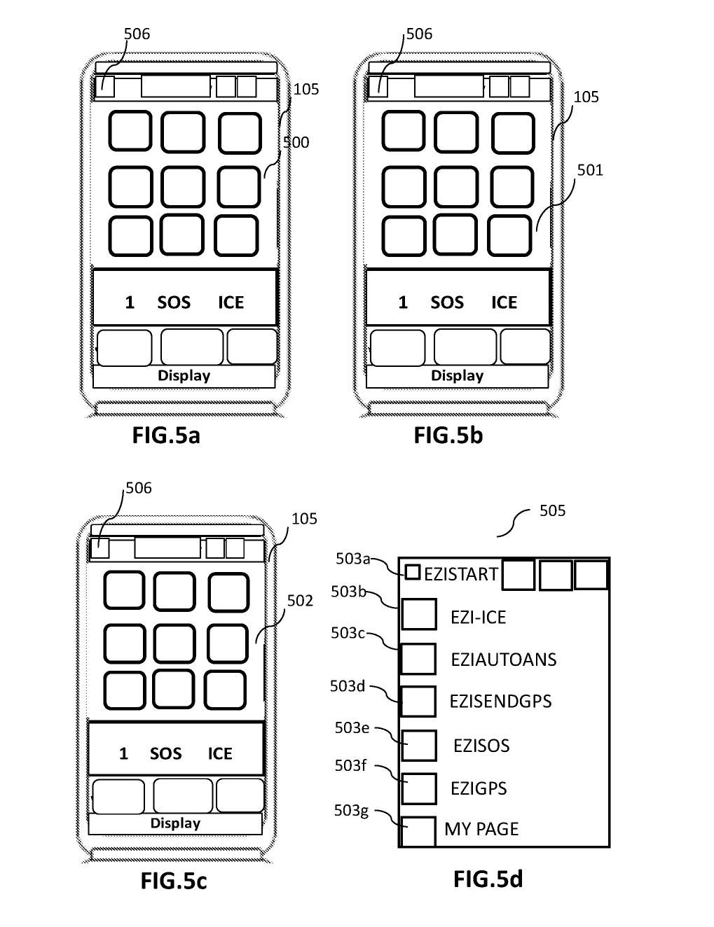

FIGS. 5a-5c are schematic illustrations of example first, second and third supplemental user interfaces 500, 501 and 502 of the mobile device 105, in accordance with an embodiment of the present disclosure. In an embodiment, the mobile device carrier 100 may be provided with a computer program product embodied as computer-readable instructions stored on a non-transient, computer-readable memory and executable by the mobile device 105 to display the first, second and third supplemental user interfaces 500, 501 and 502, apart from a default home screen of the mobile device 105. In some embodiments, the computer readable instructions may be stored locally in a memory of the mobile device 105 while in others, the instructions may be stored in a memory of the mobile device carrier 100.

The mobile device carrier 100 may further be provided with a computer program product embodied as computer-readable instructions stored on a non-transient, computer-readable memory and executable by the mobile device 105 to display one of the supplemental user interfaces 500, 501 and 502, when it operates in the integrated mode, and display the default home screen when it operates in the normal mode.

In an embodiment, the computer program product executable by the mobile device 105 is a suite of first through seventh applications 503a through 503g (FIG. 5d) that are displayed in a sub-menu 505 upon tapping of an application menu 506.

In another embodiment, the first application 503a is a launcher application which sits on top of the default home screen of the mobile device 105 for providing a supplemental user interface such as 500, 501 or 502 on the mobile device 105, but does not prevent the use of the default home screen and corresponding native functionalities. In an example embodiment, the first, second and third user interfaces 500, 501 and 502, correspond with three user selectable launcher applications: Ezilite, Ezilink, and Ezistart. A user may select to employ any of these launcher applications in accordance with the level of simplicity desired.

The second through seventh applications 503b through 503g are common for all the three user selectable launcher applications. In an example, the second application 503b ‘Ezi-ICE’ provides ICE functionality, the third application 503c ‘Ezi-AutoAns’ provides user programmable automatic call answering, the fourth application 503d ‘EziSendGps’ provides a user controlled ad hoc position transmitter for transmitting current GPS coordinates of the mobile device 105 to user selected numbers, the fifth application 503e ‘EziSoS’ provides SOS functionality, the sixth application 503f ‘EziGPS’ provides a remote GPS interrogation handler and programmable periodic GPS position transmitter, and the seventh application 503g ‘MyPage’ provides an applications organizer. The ‘My page’ 503g is a dedicated user page with user selectable applications enabling the user to program one or more applications.

The first through seventh applications 503a through 503g together with the integrated multi-language keypad 400 (FIG. 4) facilitates accessibility and usability of multiple features and functions.

In an embodiment, upon activation of the SOS application, the mobile device 105 is configured to send a preprogrammed alert SMS to one or more predefined phone numbers, and/or include its GPS co-ordinates in the preprogrammed alert SMS, and/or make an emergency call to a predefined phone number. In an example embodiment, the GPS co-ordinates may include a URL link a live, interactive map available online, where clicking on the link shows the position of the mobile device 105 on the interactive map.

In another embodiment, upon activation of the ‘Ezi-ICE’ application, the mobile device 105 is configured to retrieve and display a password protected personal information file stored in corresponding memory for use in a medical emergency (internationally denoted as ICE—In Case of Emergency). Changing data of the personal information file may be protected by password. For use in the medical emergency, the personal information file may include personal data such as user's name, person's unique identification number, address, relative's contact details, doctor name, previous and present illness, medication, allergies and user selected pictures of medicine.

FIGS. 5a-5d are merely examples, which should not unduly limit the scope of the claims herein. A person skilled in the art will recognize many variations, alternatives, and modifications of presently disclosed embodiments.

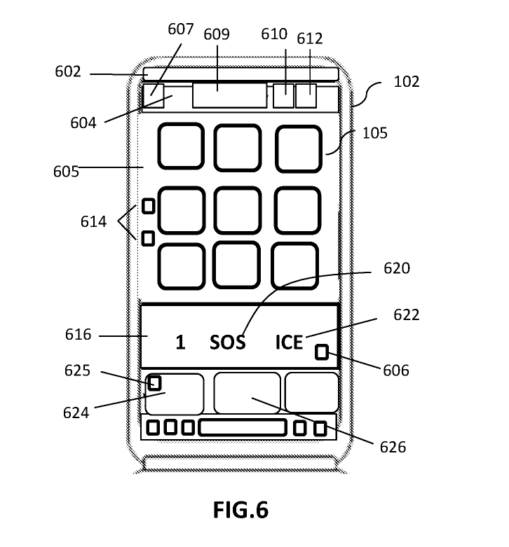

FIG. 6 is a schematic detailed illustration of a user interface 600 of the mobile device 105, corresponding to a launcher application ‘EziStart’ executing therein, in accordance with an embodiment of the present disclosure. In an embodiment, the mobile device 105 is fitted onto the back panel 102 of the mobile device carrier, which includes an alphanumeric keypad 602 (similar to the keypad 400 of FIG. 4) in the corresponding cover panel 104.

The user interface 600 displays a standard OS notification area 602, a first menu ribbon 604, and a contact display area 605. The contact display area 605 displays contacts of the mobile device 105 in an image format. In an example, the contact display area 605 includes three pages, which can be opened by swiping or tapping icon 606.

The menu ribbon 604 includes an application menu 607 for displaying a sub-menu (such as sub-menu 505 of FIG. 5d), a dialing icon 609 for automatically dialing a contact selected in the contact display area 605, a message composer icon 610 for initiating a message composition for a contact selected in the contact display area 605, and an email composer icon 612 for initiating an email composition for a contact selected in the contact display area 605.

In addition to images, pictures and icons, the contact display area 605 includes numbers 614 (0 to 9) and character keys 625 (y and z). In an embodiment, a long press on a corresponding key on the keypad 602 activates an action to the particular contact depending on the selection 609, 610, or 612.

The user interface 600 further displays another menu ribbon 616 which includes a page indicator 618 for displaying a page number of the contact display area 605, icon 620 for activating the SOS application, icon 622 for activating the ‘Ezi-ICE’ application, and the icon 606 for navigating among the pages of the contact display area 605. In one embodiment, the menu ribbon 616 displays notifications in large text in intelligent form for battery and calendar status. For example, when the energy level of a battery powering the user mobile device 100 has fallen to 10%, a message may be displayed instructing the user to connect a charger.

The user interface 600 further displays a call log icon 624 for displaying missed calls and enabling a user to access call logs, a message log icon 626 for displaying new messages and enabling a user to access message logs, and an application display area 628 for enabling a user to position five user selectable applications.

The user interface 600 provides one touch call generation, SMS and email generation, all supporting ease of use. Further, the user interface 600 combines the functions of direct dialing, direct SMS and e-mail generation, access to SOS function and ICE personal and medical data, personal details file and a menu icon 607 to access all the applications.

The user interface 600 may be operated either independently or in integration with the keypad 602. In an embodiment, when the cover panel 104 is closed and then opened, the user interface 600 appears as the Start screen of the mobile device 105. Thus, for users who get lost in navigating to others screens and applications, closing and opening the cover panel 104 causes the selected launcher application to pop up. The keypad 602 when integrated with the mobile device 105 has a short cut which when activated brings up a mouse pointer mode. In the mouse pointer mode, navigation of the pointer is done with the navigation keys of the keypad 602.

FIG. 6 is merely an example, which should not unduly limit the scope of the claims herein. A person skilled in the art will recognize many variations, alternatives, and modifications of presently disclosed embodiments.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

1. A mobile device carrier, comprising:
a back panel configured to receive and electrically couple with a mobile device, so as to at least partially cover a back of the mobile device;
pivotally coupled with the back panel, a cover panel comprising:
an interior surface configured to at least partially cover a front face of the mobile device and including a first set of actuators arranged to enable a user to enter data into the mobile device; and
an exterior surface including a second set of actuators arranged to enable input to the mobile device; and
a computer program product embodied as computer-readable instructions stored on a non-transient, computer-readable memory and executable by the mobile device to cause the mobile device to perform functions in response to actuation of the first and second sets of actuators.

2. The mobile device carrier as set forth in claim 1, wherein the first set of actuators includes a plurality of keys, each comprising a perimeter and an off-center depression configured to partially receive a finger of a user.

3. The mobile device carrier as set forth in claim 2, wherein the plurality of keys includes a plurality of alphanumeric keys, a navigation key, a contact display key, a calendar key, a call termination key, a call answering key, an enter key, an SMS messaging key, a backspace key, a right delete key, a shift key, a control key, a menu key, a home key, a back key, and one or more volume control keys.

4. The mobile device carrier as set forth in claim 3, wherein at least one of the plurality of alphanumeric keys is a multi-language key enabling data input to the mobile device in a plurality of languages.

5. The mobile device carrier as set forth in claim 4, wherein each key includes indicia corresponding with at least one action performed in response to user engagement with the key.

6. The mobile device carrier as set forth in claim 2, wherein the cover panel includes a pivot adjacent to the off-center depression of each key and first, second, third and fourth metal dome actuators adjacent to the perimeter of each key and electrically coupled with the back and cover panels.

7. The mobile device carrier as set forth in claim 6, wherein, upon application of a force to a portion of the perimeter, the key is configured to unite one of first, second, third and fourth studs at the perimeter with one of the first, second, third and fourth metal dome actuators.

8. The mobile device carrier as set forth in claim 7, wherein, in response to motion of a finger within the off-center depression towards a portion of the perimeter, each key is configured to rock towards that portion of the perimeter and engage one of the metal dome actuators to send a signal through the cover panel to the mobile device.

9. (canceled)

10. The mobile device carrier as set forth in claim 1, wherein the cover panel further comprises a window through which a portion of the mobile device is viewable when the cover panel covers the front face of the mobile device, wherein the computer-readable instructions of the computer program product are further configured to cause the mobile device to present to a user at the window, at least one of: identification of a calling entity, call status, missed calls, new e-mail, new SMS, calendar notifications, radio signal and battery status.

11. The mobile device carrier as set forth in claim 1, wherein upon actuation by a user, at least one of the second set of actuators is configured to answer a call incoming to the mobile device, at least one of the second set of actuators is configured to terminate a call received at the mobile device, at least one of the second set of actuators is configured to activate a loudspeaker of the mobile device, at least one of the second set of actuators is configured to control the back lighting for the keyboard, and at least one of the second set of actuators is configured to charge the cover panel, while the cover panel covers the mobile device front face.

12. The mobile device carrier as set forth in claim 1, wherein at least one of the second set of actuators includes a programmable SOS button configured to transmit an emergency communication, and an exterior surface of cover panel includes an SOS switch cover configured to cover the programmable SOS button to prevent false actuation thereof.

13. The mobile device carrier as set forth in claim 12, wherein the transmitting of the emergency communication includes, in accordance with computer-readable instructions of the computer program product, at least one of: sending a preprogrammed alert SMS including GPS co-ordinates, to one or more predefined mobile numbers, and making an emergency call to a predefined phone number.

14. The mobile device carrier as set forth in claim 1, further comprising a serial bus plug configured to operatively couple the mobile device carrier to a serial bus port of the mobile device, wherein the first and second sets of actuators are configured to operatively couple with the mobile device through the serial bus plug to perform functions of the mobile device in accordance with computer-readable instructions of the computer program product.

15. The mobile device carrier as set forth in claim 1, wherein the first and second sets of actuators are configured to operatively couple with the mobile device through a personal area communications network to perform functions of the mobile device in accordance with computer-readable instructions of the computer program product.

16. The mobile device carrier as set forth in claim 1, wherein the computer readable instructions are stored locally in a memory of at least one of: the mobile device and mobile device carrier.

17. The mobile device carrier as set forth in claim 1, wherein the computer program product is further executable to cause the mobile device to display at least one supplemental user interface in addition to a home screen of the mobile device.

18. The mobile device carrier as set forth in claim 17, wherein, in response to pivoting of the cover panel interior surface into an abutting relationship with the back panel followed by pivoting of the cover panel interior surface away from the back panel, the mobile device resets to a predetermined home page of the at least one supplemental user interface.

19. The mobile device carrier as set forth in claim 18, wherein the at least one supplemental user interface includes a contact display area configured to display one or more contacts of the mobile device in a image format, a dialing icon configured to cause the mobile device to dial one of the one or more contacts in response to a selection of an image of the one contact in the contact display area, a message composer icon configured to cause the mobile device to initiate message composition for one of the one or more contacts in response to a selection of an image of the one contact in the contact display area, and an email composer icon configured to cause the mobile device to initiate email composition for one of the one or more contacts in response to a selection of an image of the one contact in the contact display area.

20. (canceled)

21. The mobile device carrier as set forth in claim 17, wherein the at least one supplemental user interface displays a call log icon configured to present call logs in response to actuation of the call log icon, a message log icon configured to cause a presentation of message logs in response to actuation of the message log icon, and an application display area configured to cause a presentation of at least one user selectable application therein.

22. The mobile device carrier as set forth in claim 21, wherein the at least one supplemental user interface includes a first emergency icon configured to transmit an emergency communication in accordance with an SOS application.

23. (canceled)

24. (canceled)

25. (canceled)
